(19) United States
(12) Patent Application Publication
(10) Pub. No.: US 2013/0318933 A1
(43) Pub. Date: Dec. 5, 2013

(54) DYNAMIC CYCLONE SEPARATOR, WITH AN AXIAL FLOW AND HAVING A VARIABLE CONFIGURATION

(71) Applicants: Liberato Giampaolo Ciccarelli, San Giuliano Milanese (MI) (IT); Massimo Iovane, Sordio (LO) (IT); Michele Margarone, San Donato Milanese (MI) (IT); Paolo Andreussi, Pisa (PI) (IT); Alberto Ansiati, Prato (PO) (IT)

(72) Inventors: Liberato Giampaolo Ciccarelli, San Giuliano Milanese (MI) (IT); Massimo Iovane, Sordio (LO) (IT); Michele Margarone, San Donato Milanese (MI) (IT); Paolo Andreussi, Pisa (PI) (IT); Alberto Ansiati, Prato (PO) (IT)

(73) Assignee: Eni S.P.A., Roma (IT)

(21) Appl. No.: 13/990,911

(22) PCT Filed: Dec. 1, 2011
(86) PCT No.: PCT/IB2011/055403

§ 371 Date: Aug. 6, 2013

(30) Foreign Application Priority Data
Dec. 3, 2010 (IT) MI2010A002239

(51) Int. Cl. B01D 50/00

(52) U.S. Cl. CPC B01D 50/002
USPC 55/337

(57) ABSTRACT

Dynamic cyclone separator, with an axial flow, having a variable configuration and tubular structure (1) comprising: vortex-generating means (2) having a variable configuration, consisting of a central support (3) and a plurality of axial fins (4) having an adjustable tilt; a central support (3) having an ogival configuration which is such as to define with the outer tubular structure (1) a convergent-divergent duct in which the gas expands adiabatically; a tubular porous wall (1b) in the area of maximum velocity for capturing the particulate.

The present invention relates to a dynamic cyclone separator with an axial flow and variable configuration.

More specifically, the present invention relates to the field of plants and equipment for the separation of gaseous streams from liquids, entrained with them, and from condensable gaseous components.

Even more specifically, the separation device, object of the present invention, can be used in various steps of the treatment of natural gas, for the dehydration and/or removal of selected condensable, gaseous components which contribute to forming the stream of natural gas.

Axial-flow cyclones are normally used in process industry for the abatement of liquid and solid particulate entrained by a gas stream. In these systems, the centrifugal acceleration is conferred to the fluid by vortex-generating consisting of a system of fins, or swirlers, having a suitable geometry. These vortex-generating means are contained in a vertical separator tube. The gas and particulate enter the vertical tube and flow upwards passing through these vortex-generating means which confer a considerable centrifugal force to the fluid. The particulate is pushed against the walls of the tube and is continuously removed through a certain number of openings situated on the walls of the tube and pushed by the gas into an annular chamber where the separated particulate is sent towards an outlet.

Axial-flow cyclones are dimensioned using semi-empirical project equations of the type:

ν_{G}\sqrt{ρ_{G}}=k

wherein ρ_{G} is the gas density and K an empirical constant which allows the maximum velocity v_{G} of the gas to be obtained and, consequently, the maximum gas flow-rate treatable.

At the maximum gas flow-rate treatable, the separation efficiency is equal to 100%, for particles having a larger diameter with respect to a certain shear diameter. The separation efficiency depends on both the flow-rate, and therefore the velocity of the inlet gas, and also by the distribution of particulate entering the separator.

In Italian patent application FI2006A000114 in the name of TEA Sistemi, for example, an axial-flow cyclone is described in which it is possible to modify the motion field inside the flow by operating on the angle of inclination of the fins of the vortex-generating means, so as to maintain the same separation efficiencies within a wide range of flow-rates and distributions of particulate in the inlet gas.

The separation system proposed by the known art has some efficiency limits in the separation of the liquid particulate, above all when the distribution of the same has dimensions in the order of microns.

An objective of the present invention is to improve the characteristics of axial-flow cyclone with a variable internal configuration, described in the above-mentioned patent application, in order to improve the separation efficiency, enhancing the removal of selected condensable compounds and adopting porous means for the capturing and separation of the liquid particulate.

In order to overcome the current above-mentioned limits of axial-flow cyclone having a variable configuration of the known art, the present invention, better described in the enclosed claims, which are an integral part of this description, proposes a tubular configuration characterized by vortex-generating means, which envisages an optimized profile of the body inside the tube so as to allow the gaseous stream, entering the tube and coming into contact with the vortex-generating means, which impart a high centrifugal force to the fluid, undergoes an acceleration and subsequent expansion with a decrease in the temperature to below the condensation value of the component to be separated.

Furthermore, the recovery of the liquid particulate from the wall is obtained by the introduction of a porous wall in correspondence with the high-velocity area, which allows the absorption of the liquid particulate, even having microscopic dimensions, which come into contact with the wall.

An object of the present invention therefore relates to a dynamic separation device, cyclonic with an axial flow, having a variable configuration and tubular structure, suitable for improving the liquefaction and separation of a condensable gas inside a gaseous mixture, comprising:
a. vortex-generating means having a variable configuration, consisting of a central support and a plurality of axial fins having an adjustable tilt to impart a variable radial component to the rate of the gas flow;
b. a central support having an ogival configuration which is such as to define, with the outer tubular structure, a convergent-divergent duct in which the gas, by expanding adiabatically, causes the condensation of the condensable product selected, with the further generation and/or growth of liquid particulate;
c. a porous wall of the tubular structure, corresponding to the maximum velocity area, for capturing the liquid particulate, which reaches the wall due to the effect of the rotation imparted by the vortex-generating means, and its separation from the gaseous stream.

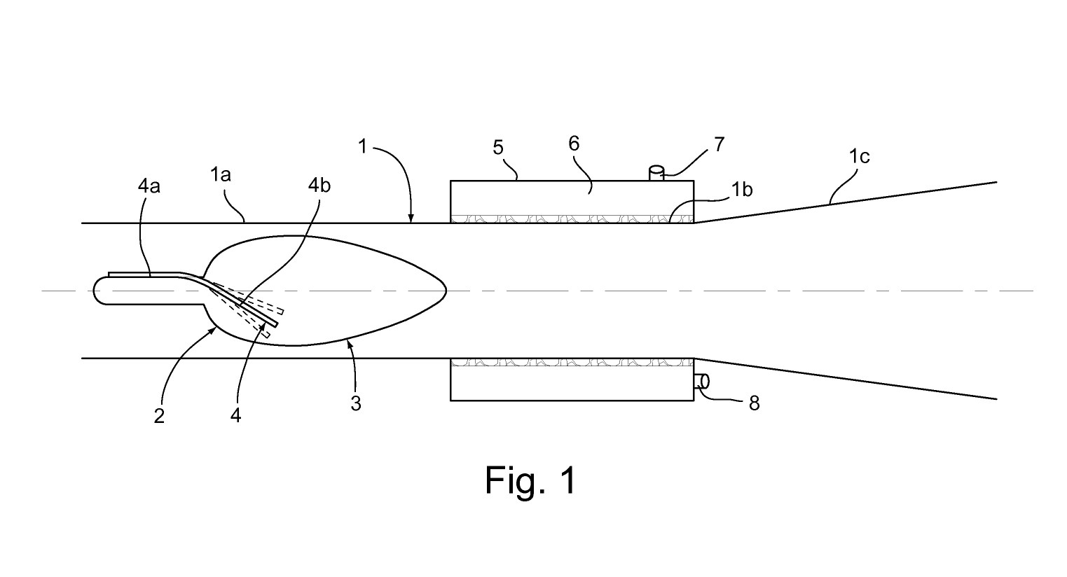

The dynamic cyclone separating device with an axial flow and a variable configuration, object of the present invention, can be better illustrated with reference to FIG. 1, which represents an illustrative but non-limiting embodiment of the same.

FIG. 1 describes a cyclone device with an axial flow and with a variable configuration for the abatement of the liquid particulate contained in a gas stream and for the condensation of a selected condensable component. The device comprises a tubular duct 1, consisting of three portions 1a, 1b and 1c, into which the stream of gas to be treated is fed (gas flow from top to bottom in the FIGURE) and vortex-generating means 2 suitable for imparting a centrifugal acceleration to the gas stream, which is sufficient for pushing the particulate against the wall of the duct. The vortex-generating means 2 are substantially situated at the inlet of the first section of the tubular duct 1a and consist of a central support 3 extending coaxially to the duct 1 and a plurality of axial fins 4 angularly equispaced (of which only one is shown in the FIGURE) which extend from the support 3 for a certain portion of the same. The fins are composed of at least two portions, one of which substantially meridian 4a and a tilted portion 4b with respect to the axis of the duct. The tilted portion 4b of each fin is hinged to the respective substantially meridian portion 4a by means of a section in plastic/deformable material. Means are envisaged for the regulation of the tilted portion (not illustrated) according to the gas flow-rate and concentration and dimension of the liquid particulate inside the stream of gas to be treated. Said regulation means allow the angular displacement of the portion 4b of the fin 4, as illustrated in FIG. 2 by a dashed or compact line, from its normal position (tilted by 45° with respect to the fixed portion 4a), to tilted positions at angles larger or smaller than 45°.

The central support 3 is such as to have an ogival configuration which, situated inside the first section of the tube 1a, generates an annular convergent-divergent chamber. The fluid mixture at the outlet of the vortex-generating means 2, passing within said annular convergent-divergent chamber, first undergoes an acceleration and subsequently a progressive expansion of the gas, causing a pressure drop and temperature decrease which induces the condensation of the selected components of the gas flow.

The wall of the second section of the tubular duct 1b consists of a porous wall in correspondence with the end portion of the ogive, in the maximum velocity area. In correspondence with and externally to said porous wall, an outer tube having a larger diameter 5 is fixed coaxially, such as to delimit, with the inner porous wall of the second section of the pipe 1b, an annular chamber 6. A radial mouth 7 is envisaged along the outer tube, for the discharge of the secondary gas flow, which accompanies the liquid to be separated through the porous wall 1b, and an axial mouth 8 for the discharge of the flow of liquid separated. Downstream of the annular separation chamber, the third section of the diverging pipe 1c allows the flow to decelerate so as to transform the kinetic energy into potential energy thus allowing a pressure recovery.

1. A dynamic, cyclonic separator, with an axial flow, having a variable configuration and tubular structure comprising:
a. vortex-generating means having a variable configuration, consisting of a central support and a plurality of axial fins having an adjustable tilt to impart a variable radial component to the gas flow rate;
b. a central support having an ogival configuration which is such as to define with the outer tubular structure a convergent-divergent duct in which the gas, by adiabatically expanding, causes the condensation of the condensable product selected, with the further generation and/or growth of liquid particulate; and
c. a porous wall of the tubular structure, corresponding to the maximum velocity area, for capturing the liquid particulate, which reaches the wall due to the effect of the rotation imparted by the vortex generating means, and separation of the same from the gaseous stream.

2. The device according to claim 1, wherein the tubular structure comprises three portions, the first suitable for receiving the central body, the second porous, downstream of the first portion, positioned in correspondence with the maximum velocity area of the gas, and the third downstream of the second portion, with a divergent transversal section, for the deceleration of the gas.

3. The device according to claim 1, wherein the central support generates the convergent-divergent annular chamber with the inner surface of the first section of the tubular structure.
